(19) United States
(12) Patent Application Publication
(10) Pub. No.: US 2021/0013772 A1
(43) Pub. Date: Jan. 14, 2021

(54) MOTOR DEVICE

(71) Applicant: CASTING MACHINING ENGINEERING CO., LTD., Changsha City (CN)

(72) Inventor: Hsiang Kao, Taoyuan City (TW)

(21) Appl. No.: 16/924,226

(22) Filed: Jul. 9, 2020

(30) Foreign Application Priority Data
Jul. 11, 2019 (CN) 201921083246.4

(51) Int. Cl. H02K 5/24

(52) U.S. Cl. CPC H02K 5/24

(57) ABSTRACT

A motor device comprises a motor body, a one-piece shaft and a fixing plate. The one-piece shaft is connected to the motor body and an end of the one-piece shaft has an impeller connecting structure. The fixing plate is fixed on the motor body and surrounds the one-piece shaft. The motor device may further comprise a connecting base, a shielding plate and a ring-shaped frame. The connecting base is connected to the fixing plate. The shielding plate is disposed on the connecting base. The ring-shaped frame is connected to the shielding plate. The one-piece shaft of the invention can reduce cumulative tolerance, enhance motor performance, save space, save material, save manufacturing cost, and reduce danger. Furthermore, the shielding plate and the ring-shaped frame protect the one-piece shaft therein, so as to provide strong protection for the one-piece shaft and prevent a person from being harmed during high speed rotation.

### BACKGROUND OF THE INVENTION

### 1. Field of the Invention

The invention relates to a motor device and, more particularly, to a motor device equipped with a one-piece shaft having an impeller connecting structure.

### 2. Description of the Prior Art

At present, there are various motor shafts with different sizes, so pump shafts need to be manufactured in various sizes for purpose of assembly. Since the shapes of some motors with powers of 0.25 Hp to 60 Hp are different, the installation position of the pump shaft has to be adjusted according to the shape of the motor. In the prior art, the motor shaft and the pump shaft are connected to each other by a coupling and then an impeller is attached to the pump shaft. After the assembly is completed, a connecting base needs to be installed to protect the pump shaft and the impeller, so as to prevent a person from being harmed during high speed rotation.

A related art China Patent Application No. 201720625140.7 discloses a connecting structure for connecting a motor shaft and a pump shaft, wherein the connecting structure comprises a coupling and a plurality of connecting parts. When the coupling disengages from the motor shaft, the pump shaft is not separated from the motor shaft since the pump shaft is connected to the motor shaft by the connecting parts, so as to prevent the pump shaft from coming off the coupling and then prevent the impeller from being damaged. However, since the motor shaft and the pump shaft are independent, it will increase cumulative tolerance and total length and waste material, cost, time and effort. Another related art China Patent Application No. 201220727552.9 discloses a mine submersible pump with abrasion resistance and corrosion resistance. The pump shaft is made of stainless steel. The front end of the outer cover of the motor is fixed with the pump body through standard parts on the outer wall of the outer cover of the motor. The standard parts are made of 2Cr13 alloy. Compared with the prior art, the mine submersible pump has the advantages of reasonable design, simple structure, good effect and so on. However, the motor shaft and the pump shaft are still independent, it is inconvenient to use, and vibration cannot be reduced well, such that it cannot be used widely.

### SUMMARY OF THE INVENTION

The invention provides a motor device equipped with a one-piece shaft having an impeller connecting structure, so as to solve the aforesaid problems.

According to an embodiment of the invention, a motor device comprises a motor body, a one-piece shaft and a fixing plate. The one-piece shaft is connected to the motor body and an end of the one-piece shaft has an impeller connecting structure. The fixing plate is fixed on the motor body and surrounds the one-piece shaft.

In another embodiment, the motor device further comprises a connecting base, a shielding plate and a ring-shaped frame. The connecting base is connected to the fixing plate. The shielding plate is disposed on the connecting base. The ring-shaped frame is connected to the shielding plate.

In another embodiment, the ring-shaped frame surrounds the one-piece shaft.

In another embodiment, a bottom of the motor body has a socket and the motor device further comprises a vibration absorber disposed on the socket.

In another embodiment, the vibration absorber is made of rubber.

In another embodiment, the motor device further comprises a magnetic plate disposed on the vibration absorber, the socket has an installation recess, and the magnetic plate is fixed in the installation recess by a magnetic attraction force to fix the vibration absorber on the socket.

As mentioned in the above, the motor device of the invention is equipped with the one-piece shaft instead of two independent shafts (i.e. motor shaft and pump shaft) of the prior art. Since the one-piece shaft has the impeller connecting structure configured to connect an impeller to the one-piece shaft, the invention does not need to assemble two independent shafts (i.e. motor shaft and pump shaft) like the prior art, such that the one-piece shaft of the invention can reduce cumulative tolerance, enhance motor performance, save space, save material, save manufacturing cost, and reduce danger. Furthermore, the invention may utilize the shielding plate and the ring-shaped frame to protect the one-piece shaft therein, so as to provide strong protection for the one-piece shaft and prevent a person from being harmed during high speed rotation. Still further, the invention may install the vibration absorber on the bottom of the motor body to reduce vibration and increase the lifetime of the motor device. Moreover, the vibration absorber may be rapidly installed on the bottom of the motor body by means of the magnetic plate and the installation recess, such that it is very convenient to assemble, disassemble and replace the vibration absorber.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a perspective view illustrating a motor device according to an embodiment of the invention.

FIG. 2 is a perspective view illustrating parts of the motor device shown in FIG. 1 from another viewing angle.

FIG. 3 is a side view illustrating the motor device shown in FIG. 2.

FIG. 4 is a side view illustrating the assembly of the motor device shown in FIG. 1.

### DETAILED DESCRIPTION

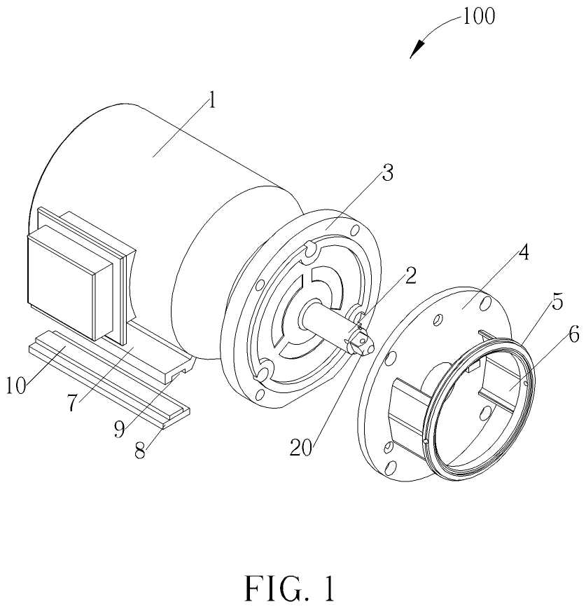

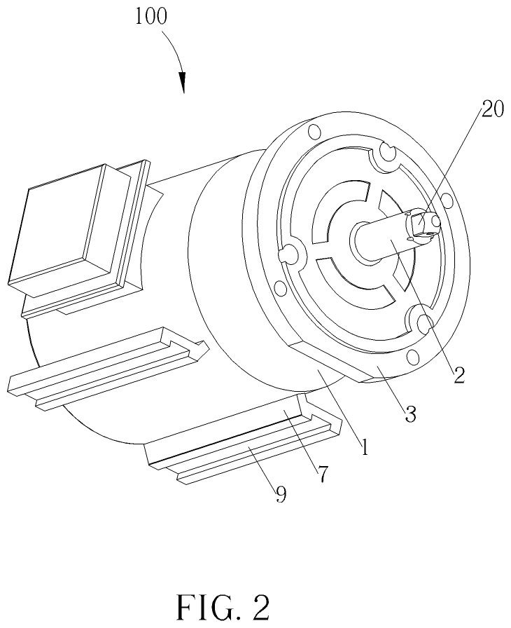

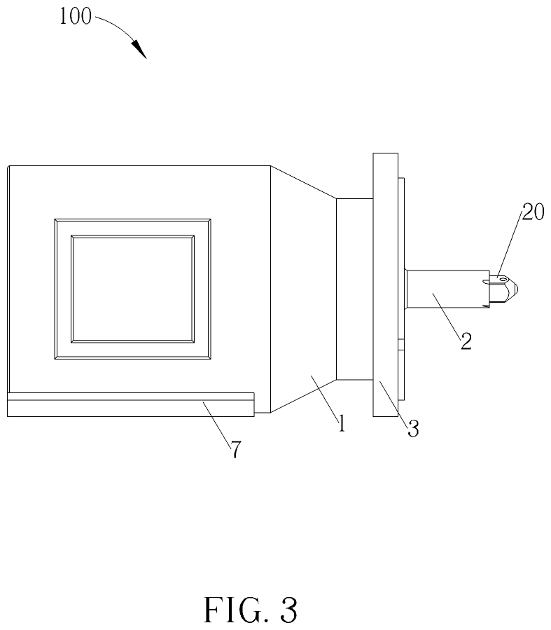

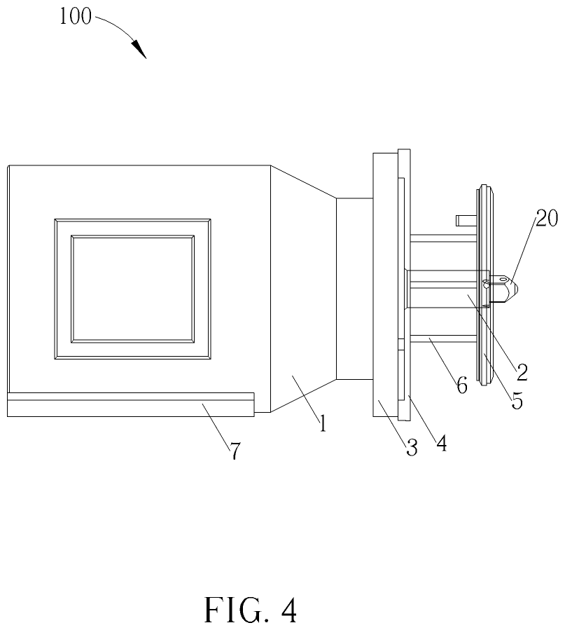

Referring to FIGS. 1 to 4, FIG. 1 is a perspective view illustrating a motor device 100 according to an embodiment of the invention, FIG. 2 is a perspective view illustrating parts of the motor device 100 shown in FIG. 1 from another viewing angle, FIG. 3 is a side view illustrating the motor device 100 shown in FIG. 2, and FIG. 4 is a side view illustrating the assembly of the motor device 100 shown in FIG. 1.

As shown in FIGS. 1 to 4, the invention provides a motor device 100, wherein the motor device 100 comprises a motor body 1, a one-piece shaft 2, a fixing plate 3, a connecting base 4, a ring-shaped frame 5, a shielding plate 6, a socket 7 and a vibration absorber 8.

The one-piece shaft 2 is connected to the motor body 1 and an end of the one-piece shaft 2 has an impeller connecting structure 20. The impeller connecting structure 20 is configured to connect an impeller (not shown) to the one-piece shaft 2, such that the one-piece shaft 2 does not need to equipped with a pump shaft like the prior art. The fixing plate 3 is fixed on the motor body 1 and surrounds the one-piece shaft 2. In this embodiment, the fixing plate 3 may be welded on a side of the motor body 1.

The connecting base 4 is connected to the fixing plate 3. In this embodiment, the connecting base 4 may be connected to the fixing plate 3 by screws. In this embodiment, two shielding plates 6 may be disposed on the connecting base 4 symmetrically and the ring-shaped frame 5 is connected to the shielding plates 6. Accordingly, the connecting base 4 and the ring-shaped frame 5 are connected with each other integrally through the shielding plates 6. When the connecting base 4 is connected to the fixing plate 3, the ring-shaped frame 5 surrounds the one-piece shaft 2, such that the shielding plates 6 and the ring-shaped frame 5 can protect the one-piece shaft 2 therein, so as to provide strong protection for the one-piece shaft 2 and prevent a person from being harmed during high speed rotation.

In this embodiment, a bottom of the motor body 1 may have two sockets 7 and the motor device 100 may comprise two vibration absorbers 8 disposed on the sockets 7, respectively. The vibration absorber 8 may be made of rubber, but is not so limited. Furthermore, the motor device 100 may further comprise a magnetic plate 10 disposed on each of the vibration absorbers 8 and each of the sockets 7 may have an installation recess 9. The magnetic plate 10 can be fixed in the installation recess 9 by a magnetic attraction force to fix the vibration absorber 8 on the socket 7. Accordingly, the vibration absorber 8 can be assembled, disassembled and maintained rapidly, such that it is very convenient to assemble, disassemble and replace the vibration absorber 8 and the vibration absorber 8 can provide good support and reduce vibration for the motor body 1.

### Operation Principle:

In the prior art, a pump shaft needs to be assembled to a motor shaft by a coupling. However, the invention uses the one-piece shaft 2 to remove the pump shaft and the coupling. For further explanation, since the one-piece shaft 2 has the impeller connecting structure 20 for connecting an impeller (not shown), the pump shaft and the coupling of the prior art are not needed and can be removed. Since the one-piece shaft 2 of the invention can output power directly (i.e. the power outputted by the one-piece shaft 2 does not need to be transmitted to a pump shaft through a coupling), the power outputted by the one-piece shaft 2 will not decrease. Still further, the shielding plate 6 may be shortened according to the length of the one-piece shaft 2, so as to reduce the cost of material. The standards of the connecting base 4 may be reduced to a few number of general standards, so as to satisfy the manufacturing requirements and reduce the cost of management. Moreover, the number of parts needed to be replaced is reduced and the cost of maintenance is also reduced, such that the income can be increased for a client.

The ring-shaped frame 5 and the shielding plate 6 protect the one-piece shaft 2 well, so as to prevent a person from being harmed during high speed rotation. Since the one-piece shaft 2 and the motor body 1 are protected, the lifetime of the motor device 100 can be increased.

In the invention, unless there is a definite limitation, the terms “install”, “dispose”, “connect”, “fix” and “pivotally connect” should be broadly explained. For example, two parts may be connected fixedly, connected detachably, formed integrally, connected mechanically, connected electrically, connected directly, or connected via intervening medium. Also, two parts may communicate with each other inside or interact with each other. Unless there is a definite limitation, one person skilled in the art may understand a specific meaning of the aforesaid terms in the invention according practical applications.

As mentioned in the above, the motor device of the invention is equipped with the one-piece shaft instead of two independent shafts (i.e. motor shaft and pump shaft) of the prior art. Since the one-piece shaft has the impeller connecting structure configured to connect an impeller to the one-piece shaft, the invention does not need to assemble two independent shafts (i.e. motor shaft and pump shaft) like the prior art, such that the one-piece shaft of the invention can reduce cumulative tolerance, enhance motor performance, save space, save material, save manufacturing cost, and reduce danger. Furthermore, the invention may utilize the shielding plate and the ring-shaped frame to protect the one-piece shaft therein, so as to provide strong protection for the one-piece shaft and prevent a person from being harmed during high speed rotation. Still further, the invention may install the vibration absorber on the bottom of the motor body to reduce vibration and increase the lifetime of the motor device. Moreover, the vibration absorber may be rapidly installed on the bottom of the motor body by means of the magnetic plate and the installation recess, such that it is very convenient to assemble, disassemble and replace the vibration absorber.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A motor device comprising:
a motor body;
a one-piece shaft connected to the motor body, an end of the one-piece shaft having an impeller connecting structure; and
a fixing plate fixed on the motor body and surrounding the one-piece shaft.

2. The motor device of claim 1, further comprising:
a connecting base connected to the fixing plate;
a shielding plate disposed on the connecting base; and
a ring-shaped frame connected to the shielding plate.

3. The motor device of claim 2, wherein the ring-shaped frame surrounds the one-piece shaft.

4. The motor device of claim 1, wherein a bottom of the motor body has a socket and the motor device further comprises a vibration absorber disposed on the socket.

5. The motor device of claim 4, wherein the vibration absorber is made of rubber.

6. The motor device of claim 4, further comprising a magnetic plate disposed on the vibration absorber, the socket having an installation recess, the magnetic plate being fixed in the installation recess by a magnetic attraction force to fix the vibration absorber on the socket.
